(19) United States
(12) Patent Application Publication
(10) Pub. No.: US 2019/0362334 A1
(43) Pub. Date: Nov. 28, 2019

(54) Transaction Method, Payment Device, Check Device, and Server

(71) Applicant: Huawei Technologies Co., Ltd., Shenzhen (CN)

(72) Inventors: Sishan Wang, Beijing (CN); Jingqing Mei, Beijing (CN)

(21) Appl. No.: 16/462,700

(22) PCT Filed: Feb. 24, 2017
(86) PCT No.: PCT/CN2017/074736

§ 371 Date: May 21, 2019

(30) Foreign Application Priority Data
Nov. 21, 2016 (CN) 201611023113.9

(51) Int. Cl. G06Q 20/32; G06Q 20/20; G06Q 20/38

(52) U.S. Cl. CPC G06Q 20/3226; G06Q 20/3825; G06Q 20/204; G06Q 20/327

(57) ABSTRACT

A transaction method includes sending, by a payment device, personal identification number (PIN)-less request information to a check device a PIN-less identifier, where the PIN-less identifier indicates that a card for a transaction has a PIN-less capability, the PIN-less identifier is associated with the check device and corresponds to the card, receiving, by the payment device, PIN-less answer information from the check device in response to the PIN-less request information, where the PIN-less answer information includes the PIN-less identifier, modifying, by the payment device, a cardholder verification method (CVM) list of the card based on the PIN-less answer information, generating, by the payment device, an authorization request cryptogram (ARQC), and sending, by the payment device, the ARQC to a point of sale (PoS) machine.

### TECHNICAL FIELD

This application relates to the field of electronic devices, and more specifically, to a contactless PIN-less payment transaction method, a payment device, a check device, and a server.

### BACKGROUND

A contactless payment standard released by the People's Bank of China (the people's bank of china, PBOC) includes a contactless standard debit/credit record PBOC and a contactless quick standard debit/credit record (quick PBOC, qPBOC). The qPBOC has an advantage of a short interaction time (less than 500 ms) and has good user experience. Therefore, currently most contactless transactions use a qPBOC procedure. The qPBOC supports only two cardholder verification methods (cardholder verification method, CVM): an online personal identification number (personal identification number, PIN) and a signature. For an online transaction that is performed in a physical store, in which a payee device participates, and that needs to be sent by the pay ee device to an issuing bank host for authorization, an online PIN is used for most times. An offline transaction means that, for information exchange between a payment device (for example, a mobile phone) and a payee device (for example, a point of sale device, point of sale, PoS), a network is not required, and information is exchanged between the two devices. In this case, the payment device does not need a networking capability, and the transaction is processed by the payee device. However, for an online transaction, a payment device directly interacts with an issuing bank host. Therefore, the payment device needs a networking capability but does not need a payee device. The online transaction is a type of transaction, that is, the transaction needs to be sent by the payee device to the issuing bank host for authorization, and the payee device and the issuing bank host are in communication connection with each other.

QuickPass is a brand defined based on the PBOC 2.0/3.0 standard, and currently has two mobile payment modes: a secure module (secure element, SE)-based mobile payment mode and a host card emulation (host card emulation, HCE)-based mobile payment mode. UnionPay Cloud QuickPass implements card emulation in a mobile device based on HCE and is compatible with logic of a PBOC technology.

Currently, for some industries and merchants that have a relatively large proportion of small-amount services and require a high checkout speed, the UnionPay launches a QuickPass online small-amount quick service (a small-amount signature-free and password-free service), and the merchants may apply for the service to become a whitelist merchant. When the whitelist merchant initiates an online transaction lower than a standard limit in a QuickPass manner, an integrated circuit (integrated circuit, IC) card used by a cardholder or a mobile device earning IC card information supports the small-amount quick service by default without jumping to a password input interface or perform signature verification, that is, there is no need to perform cardholder verification in a PBOC procedure, thereby implementing payment at sight for the cardholder. For a transaction that is initiated by the whitelist merchant and that satisfies conditions (QuickPass and lower than the limit), an acquirer adds a PIN-less identifier to the transaction and marks that the transaction belongs to the small-amount quick service, so that an issuing bank performs PIN-less authorization on the transaction.

Because the mobile device is introduced, currently, there is a device-based cardholder verification method (consumer device CVM, CD-CVM) or device cardholder verification, in which a device checks an identity of the cardholder in a form of a fingerprint or a digital password. Alipay launches a wearable device PIN-less function for an online transaction, and uses a feature that a carry-on wearable device can represent the identity of the cardholder, thereby adding a verification factor.

The existing Alipay wearable intelligent-device PIN-less technology is intended for an online transaction model in which no PoS machine participates. How-ever, for an offline transaction model in which a PoS machine participates, the wearable intelligent-device PIN-less technology does not exist. Currently, because it is forced that a Cloud QuickPass transaction is performed online, in other words, a transaction needs to be sent by a PoS machine to an issuing bank host for verification, interaction between a payment device and the PoS machine does not need to be performed online. For an offline HCE Cloud QuickPass PIN-less transaction processed by the PoS machine, there is only one approach. When a card supports the small-amount quick service, and when the whitelist merchant supporting the small-amount quick service performs a PIN-less transaction, an HCE application can perform a small-amount PIN-less transaction without identity verification. However, when the PoS machine and/or the HCE payment application do/does not support a small-amount PIN-less function, that is, an offline HCE Cloud QuickPass PIN-based transaction, a password always needs to be entered in an HCE-based card (including a credit card) swiping transaction.

### SUMMARY

This application provides a transaction method, a payment device, a check device, and a server, to enhance security of an HCE Cloud QuickPass transaction and improve user experience.

According to a first aspect, a transaction method is provided. The method includes: sending, by a payment device, PIN-less request information to a check device, where the PIN-less request information is used by the payment device to request the check device for a PIN-less identifier, the PIN-less identifier is used to indicate that a card for a transaction has a PIN-less capability, the PIN-less identifier is associated with the check device and corresponds to the card, and the payment device, the check device, and the card are already associated with each other; receiving, by the payment device, PIN-less answer information that is sent by the check device in response to the PIN-less request information, where the PIN-less answer information includes the PIN-less identifier; modifying, by the payment device, a cardholder verification method CVM list of the card based on the PIN-less answer information, so that a point of sale device PoS machine learns that the transaction is a PIN-less transaction; and generating, by the payment device, an authorization request cryptogram ARQC based on the PIN-less answer information, and sending the ARQC to the PoS machine, where the ARQC includes the PIN-less identifier, the ARQC is used by the PoS machine to generate an authorization request packet and send the authorization request packet to a server for the transaction, and the authorization request packet includes the ARQC.

According to the transaction method provided in the first aspect, two-factor verification is implemented after the payment device and the additional check device verify each other. Even if the payment device is lost or information about the card is thieved, because the check device further needs to be verified for a small-amount PIN-less transaction, unauthorized payment is not performed, and security of the transaction can be enhanced. For a PoS machine and/or an HCE payment application not supporting a small-amount PIN-less function, validity of verifying a PIN-less permission of the check device is used, a PIN-less function of the server is implemented by verifying the PIN-less identifier, and the PIN-less function of the PoS machine is implemented after the payment device receives a response of the check device and modifies the CVM list of the card, so that a cardholder verification process is no longer performed on the PoS machine, and a risk that a password is peeked at when the password is entered is avoided, thereby achieving higher security and better user experience.

With reference to the first aspect, in a first possible implementation of the first aspect, the modifying, by the payment device, a cardholder verification method CVM list of the card includes, setting, in the CVM list of the card, a service condition of an online personal identification number PIN to be that a transaction amount is greater than a PIN-less limit, where the PIN-less limit corresponds to the PIN-less identifier.

With reference to the first aspect or the first possible implementation of the first aspect in a second possible implementation of the first aspect, the modifying, by the payment device, a cardholder verification method CVM list of the card includes: adding a device cardholder verification method CDCVM to a CVM type in the CVM list of the card, and recording a result of the CDCVM as that verification succeeds.

With reference to any one of the first aspect or the first to the second possible implementations of the first aspect, in a third possible implementation of the first aspect, before the sending, by a payment device, PIN-less request information to a check device, the method further includes, sending, by the payment device, PIN-less verification request information to the server, where the PIN-less verification request information is used to request the PIN-less identifier for the check device, so that the server generates the PIN-less identifier based on the PIN-less verification request information, determines the PIN-less limit corresponding to the PIN-less identifier, and sends the PIN-less identifier to the check device.

With reference to any one of the first aspect or the first to the third possible implementations of the first aspect, in a fourth possible implementation of the first aspect, the check device encrypts or signs the PIN-less identifier by using a first encryption key in a first key pair, where the first encryption key is sent by the server to the check device.

With reference to any one of the first aspect or the first to the fourth possible implementations of the first aspect, in a fifth possible implementation of the first aspect, the sending, by a payment device, PIN-less request information to a check device includes, sending, by the payment device to the check device, the PIN-less request information encrypted by using a second encryption key in a second key pair, where the second key pair is generated through negotiation between the payment device and the check device, and the second key pair includes the second encryption key and a second decryption key.

With reference to any one of the first aspect or the first to the fifth possible implementations of the first aspect, in a sixth possible implementation of the first aspect, the payment device is a mobile phone and the check device is a wearable device; or the payment device is a wearable device and the check device is a mobile phone.

According to a second aspect, a transaction method is provided. The method includes: receiving, by a check device, PIN-less request information sent by a payment device, where the PIN-less request information is used by the payment device to request the check device for a PIN-less identifier, the PIN-less identifier is used to indicate that a card for a transaction has a PIN-less capability, the PIN-less identifier is associated with the check device and corresponds to the card, and the payment device, the check device, and the card are already associated with each other; and parsing, by the check device, the PIN-less request information, and sending PIN-less answer information to the payment device in response to the PIN-less request information, where the PIN-less answer information includes the PIN-less identifier, and the PIN-less answer information is used by the payment device to modify a cardholder verification method CVM list of the card.

According to the transaction method provided in the second aspect, the PIN-less identifier is stored in the check device, and the PIN-less identifier and information about the card in the payment device are separately stored. After a card is selected for each transaction, authorization is applied for from the check device, and two-factor verification is implemented after the payment device and the check device verify each other. In this way, even if the payment device is lost or the information about the card is thieved, because the check device further needs to be verified for a small-amount PIN-less transaction, unauthorized payment is not performed, thereby achieving higher security and better user experience.

With reference to the second aspect, in a first possible implementation of the second aspect, before the sending, by the check device PIN-less answer information to the payment device, the method further includes, receiving, by the check device, the PIN-less identifier that is sent by a server for the transaction, where the PIN-less identifier is generated by the server based on PIN-less verification request information sent by the payment device.

With reference to the second aspect or the first possible implementation of the second aspect, in a second possible implementation of the second aspect, before the sending, by the check device PIN-less answer information to the payment device, the method further includes: receiving, by the check device, a first encryption key in a first key pair sent by the server, where the first key pair includes the first encryption key- and a first deception key; and encrypting or signing, by the check device, the PIN-less identifier by using the first encryption key-.

With reference to any one of the second aspect or the first to the second possible implementations of the second aspect, in a third possible implementation of the second aspect, the parsing, by the check device, the PIN-less request information includes: decrypting, by the check device, the PIN-less request information by using a second decryption key in a second key pair, where the second key pair is generated through negotiation between the payment device and the check device, and the second key pair includes a second encryption key and the second decryption key.

With reference to any one of the second aspect or the first to the third possible implementations of the second aspect, in a fourth possible implementation of the second aspect, the check device is a wearable device and the payment device is a mobile phone; or the check device is a mobile phone and the payment device is a wearable device.

According to a third aspect, a transaction method is provided. The method includes, receiving, by a server, an authorization request packet sent by a point of sale device PoS machine, where the authorization request packet includes an authorization request cryptogram ARQC, the ARQC includes a PIN-less identifier that is associated with a check device and that corresponds to a card required for a transaction, the PIN-less identifier is used by the server to learn that the card has a PIN-less capability, the ARQC is sent by a payment device to the PoS machine, and the payment device, the check device, and the card are already associated with each other; and verifying, by the server based on the ARQC, whether the transaction is valid.

According to the transaction method provided in the third aspect, two-factor verification is implemented after the server verifies the PIN-less identifier stored in the check device and information about the card in the payment device. In this way, even if the payment device is lost or the information about the card is thieved, because the check device further needs to be verified for a small-amount PIN-less transaction, authorization is not performed for the transaction, thereby achieving higher security and better user experience. For a PoS machine and/or an HCE payment application not supporting a small-amount PIN-less function, validity of verifying a PIN-less permission of the check device is used, and the PIN-less transaction is authorized by verifying the PIN-less identifier, thereby achieving higher security and better user experience.

With reference to the third aspect, in a first possible implementation of the third aspect, before the receiving, by a server, an authorization request packet sent by a PoS machine, the method further includes: receiving, by the server, PIN-less verification request information sent by the payment device, where the PIN-less verification request information is used to request the PIN-less identifier for the check device; generating, by the server, the PIN-less identifier based on the PIN-less verification request information, and determining a PIN-less limit corresponding to the PIN-less identifier; and sending, by the server, the PIN-less identifier to the check device.

With reference to the first possible implementation of the third aspect, in a second possible implementation of the third aspect, the verifying, by the server based on the ARQC, whether the transaction is valid includes: when the server decrypts the ARQC and determines that the PIN-less identifier is valid and a transaction amount is less than or is equal to the PIN-less limit, determining that the transaction is PIN-less; or when the server decrypts the ARQC and determines that the PIN-less identifier is invalid, rejecting the transaction, or when the server determines that a transaction amount is greater than the PIN-less limit, determining that a password needs to be entered for the transaction.

With reference to the second possible implementation of the third aspect, in a third possible implementation of the third aspect, before the receiving, by a server, an authorization request packet sent by a PoS machine, the method further includes: generating, by the server, a first key pair, where the first key pair includes a first encryption key and a first decryption key; and sending, by the server, the first encryption key to the check device, where the first encryption key is used by the check device to encrypt or sign the PIN-less identifier; and determining, by the server by using the first decryption key in the first key pair, whether the PIN-less identifier is valid.

With reference to any one of the third aspect or the first to the third possible implementations of the third aspect, in a fourth possible implementation of the third aspect, the payment device is a mobile phone and the check device is a wearable device; or the payment device is a wearable device and the check device is a mobile phone.

According to a fourth aspect, a payment device is provided. The payment device is configured to perform the method according to any one of the first aspect or the possible implementations of the first aspect. Specifically, the payment device includes units configured to perform the method according to any one of the first aspect or the possible implementations of the first aspect.

According to a fifth aspect, a check device is provided. The check device is configured to perform the method according to any one of the second aspect or the possible implementations of the second aspect. Specifically, the check device includes units configured to perform the method according to any one of the second aspect or the possible implementations of the second aspect.

According to a sixth aspect, a server is provided. The server is configured to perform the method according to any one of the third aspect or the possible implementations of the third aspect. Specifically, the server includes units configured to perform the method according to any one of the third aspect or the possible implementations of the third aspect.

According to a seventh aspect, a payment device is provided. The payment device includes a processor, a memory, a receiver, and a transmitter. The processor, the memory, the receiver, and the transmitter are connected by using a bus. The memory is configured to store an instruction, and the receiver, the transmitter, and the processor are configured to invoke the instruction stored in the memory to perform the method according to any one of the first aspect or the possible implementations of the first aspect.

According to an eighth aspect, a check device is provided. The check device includes a processor, a memory, a receiver, and a transmitter. The processor, the memory, the receiver, and the transmitter are connected by using a bus. The memory is configured to store an instruction, and the receiver, the transmitter, and the processor are configured to invoke the instruction stored in the memory to perform the method according to any one of the second aspect or the possible implementations of the second aspect.

According to a ninth aspect, a server is provided. The server includes a processor, a memory, a receiver, and a transmitter. The processor, the memory, the receiver, and the transmitter are connected by using a bus. The memory is configured to store an instruction, and the receiver, the transmitter, and the processor are configured to invoke the instruction stored in the memory to perform the method according to any one of the third aspect or the possible implementations of the third aspect.

According to a tenth aspect, a computer readable medium is provided. The computer readable medium is configured to store a computer program, and the computer program includes an instruction used to perform the method according to any one of the first aspect or the possible implementations of the first aspect.

According to an eleventh aspect, a computer readable medium is provided. The computer readable medium is configured to store a computer program, and the computer program includes an instruction used to perform the method according to any one of the second aspect or the possible implementations of the second aspect.

According to a twelfth aspect, a computer readable medium is provided. The computer readable medium is configured to store a computer program, and the computer program includes an instruction used to perform the method according to any one of the third aspect or the possible implementations of the third aspect.

### BRIEF DESCRIPTION OF DRAWINGS

FIG. 1 is a schematic diagram of two mobile payment modes: an existing SE-based mobile payment mode and HCE-based mobile payment mode;

FIG. 2 is a schematic flowchart of existing contactless payment qPBOC;

FIG. 3 is a schematic structural diagram of an online authorization request packet in existing qPBOC;

FIG. 4 is a schematic flowchart of a small-amount PIN-less transaction performed by using an existing mobile device card;

FIG. 5 is a schematic flowchart of a transaction method according to an embodiment of the present invention;

FIG. 6 is a schematic flowchart of a transaction method according to another embodiment of the present invention;

FIG. 7 is a schematic structural diagram of an authorization request packet according to an embodiment of the present invention;

FIG. 8 is a schematic block diagram of a payment device according to an embodiment of the present invention;

FIG. 9 is a schematic block diagram of a payment device according to another embodiment of the present invention;

FIG. 10 is a schematic block diagram of a check device according to an embodiment of the present invention;

FIG. 11 is a schematic block diagram of a check device according to another embodiment of the present invention;

FIG. 12 is a schematic block diagram of a smartphone according to an embodiment of the present invention;

FIG. 13 is a schematic block diagram of a server according to an embodiment of the present invention; and

FIG. 14 is a schematic block diagram of a server according to another embodiment of the present invention.

### DESCRIPTION OF EMBODIMENTS

The following describes technical solutions in embodiments of the present invention in detail with reference to the accompanying drawings.

The following key terms are used in the embodiments of the present invention.

Authorization request cryptogram (authorization request cryptogram, ARQC): an application cryptogram generated when it is determined that online authorization is required during a transaction performed by using an IC card, and generated by encrypting such information as an authorization amount and an application transaction counter by using a key that is preset in the card by an issuing bank. For qPBOC, the cry program is returned to a PoS machine in a response of a get processing option instruction. Subsequently, the PoS machine generates an online authorization request packet by using the cryptogram and other necessary information, and sends the online authorization request packet to the issuing bank for transaction authorization.

Application transaction counter (application transaction counter, ATC): a counter in a card for indicating a quantity of transaction times (regardless whether a transaction succeeds or not).

CVM: a method for verifying an identity of a cardholder.

CD-CVM: A CDCVM is a specific cardholder verification manner for a QuickPass transaction initiated by a mobile device and currently the CDCVM is usually (including but is not limited to) a digital password and a fingerprint of a wallet application. If a mobile phone and a PoS machine both support the CDCVM in a CVM list, a result of the CDCVM is used as a cardholder verification result (the CDCVM has a highest priority in the CVM list), and an online PIN or signature does not need to be provided again. Compared with a digital password, a fingerprint is more convenient in actual use and provides better user experience (both the two manners belong to the CDCVM).

Get processing option (get processing options, GPO): an instruction sent by a PoS machine to a card in an initialization phase of a PBOC/qPBOC application. In addition, such information as transaction information, a terminal transaction attribute, and a parameter that the card previously requires a terminal to provide are attached to the instruction.

HCE: In an HCE mode, a conventional physical SE for near field communication is replaced with remotely hosted Cloud (Cloud or SE on the Cloud). Even without an SE module, a mobile device can also implement a secure near field communication application for, for example, payment, marketing, and door control.

SE: configured to store information about a virtual card and isolated from an operating system, and having extremely high security and an extremely high tamper-proof capability.

PIN: digits, commonly referred to as a password, for identifying a personal identity.

Near field communication (near field communication, NFC): NFC is a short-distance wireless connection technology, by using which communication between electronic devices within a short distance is implemented through magnetic field induction based on a radio frequency identification technology. A user can exchange information and content and perform a transaction such as near field payment in a visual, secure, and contactless manner only by touching or approaching a device. NFC works at a frequency of 13.56 MHz, and a valid range of communication is 0 cm to 20 cm.

PoS machine: a multifunctional terminal. If a PoS machine is installed on a special nominated supplier of a credit card or an admissible network and networked with computers, the PoS machine can implement automatic transfer of electronic funds and support such functions as consumption, pre-authorization, balance inquiry, and transfer, and is secure, convenient, and reliable in use.

Trusted execution environment (trusted execution environment, TEE): A trusted execution environment is an operating environment that coexists with an ordinary execution environment (or referred to as a rich execution environment, rich execution environment, REE, where in a general sense, the REE refers to an operating environment that does not have a particular security function) in an intelligent terminal. Supported by hardware, the trusted execution environment has a security capability and can meet a particular security requirement and implement an operating mechanism in which the trusted execution environment is isolated from the ordinary execution environment.

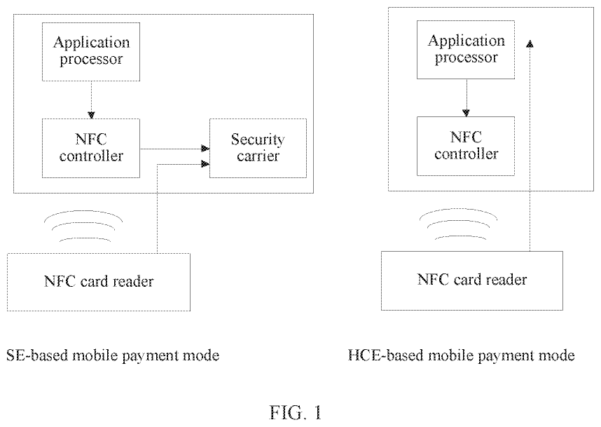

Currently, two commonly used mobile payment modes are mainly an SE-based mobile payment mode and an HCE-based mobile payment mode. UnionPay Cloud QuickPass implements card emulation in a mobile device based on HCE, and is compatible with logic of a PBOC technology. FIG. 1 is a schematic diagram of an existing SE-based mobile payment mode and an HCE-based mobile payment mode. It may be learned from FIG. 1 that, there is no SE in an HCE-based mobile payment technology. Based on the technology, without a security carrier, an NFC controller notifies an application processor of smartcard instruction data, and then the operating system notifies a specified mobile phone application of the smartcard instruction data Compared with SE-based card emulation, in a host card emulation method, any program can emulate an IC card to directly communicate with an NFC card reader. Therefore, compared with a conventional SE-based card emulation solution, a difference of the HCE solution mainly lies in that account data related to a transaction can be stored only in an REE or a TEE. Due to a lack of a secure storage environment, HCE-based QuickPass needs to integrate an additional risk management mechanism. Because there is no security carrier in the HCE-based mobile payment mode, for all HCE-based transactions, a limit key needs to be used, and it is forced that each transaction is performed online. In addition to a small-amount quick service, for each transaction, it is forced that a password is entered to ensure security.

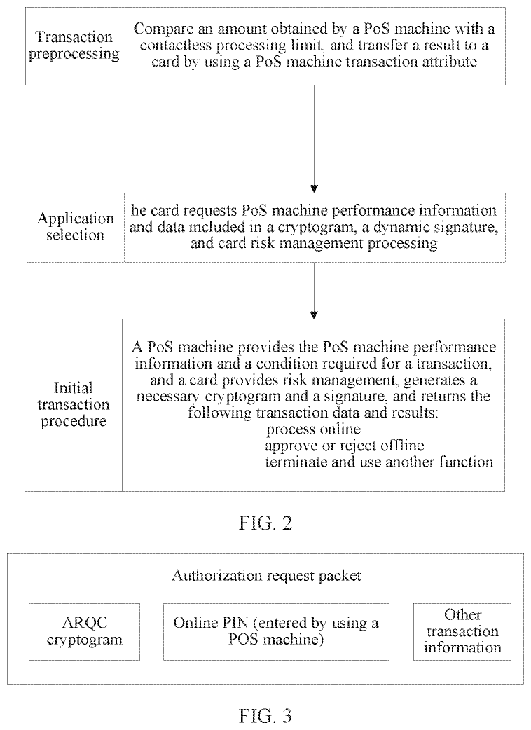

FIG. 2 is a schematic flowchart of existing contactless payment qPBOC. As shown in FIG. 2, after transaction preprocessing and application selection are completed, an initial transaction processing procedure is entered. In this process, after obtaining an authorization amount entered by a cashier, a PoS machine first performs a series of checks, for example, checks whether a currency unit meets a regulation and whether the authorization amount exceeds a CVM limit of the PoS machine. After it is checked that requirements are met, a user is required to show a card. The PoS machine sends, to the card, a GPO instruction together with transaction information such as the authorization amount and the ATC and a PoS machine parameter such as a PoS machine transaction attribute, so that the card performs operations, for example, performs risk management, determines a transaction type (offline/online/rejection), and generates a related cryptogram.

After the card feeds back a generated ARQC to the PoS machine in a GPO response, the PoS machine obtains response information of the card by using read record (Read Record) instructions. When returning a response of the last Read Record instruction, the card adds an identifier to the instruction, to notify the PoS machine that the response is the last piece of information. After receiving the response of the instruction, the PoS machine learns that reading of the information ends, that is, a GPO process and information exchange between the PoS machine and the card are already completed. In this case, the PoS machine performs a next information processing operation, and prompts the user that the user may carry the card away from the PoS machine, that is, the user may carry the card away from an induction area of the PoS machine. If the transaction is an online transaction, the card generates an ARQC cryptogram by using such parameters as an authorization amount and an ATC, and feeds back the cryptogram to the PoS machine in a GPO response. After receiving the GPO response of the card, the PoS machine determines, based on related information, whether cardholder authentication is to be performed. If cardholder authentication needs to be performed, a CVM of a highest priority supported by both a previously obtained CVM list of the card and a CVM list supported by a terminal is selected with reference to the CVM list of the card and the CVM list supported by the terminal.

For qPBOC, an online PIN is used as an optimal CVM. In this case, after the card receives the GPO response and leaves the induction area, the PoS machine prompts a cardholder to enter an online PIN on the PoS machine, adds the online PIN, the ARQC cryptogram and other information together to an online authorization request packet, and sends the online authorization request packet to an issuing bank host for verification. After the issuing bank host performs verification and feeds back a transaction authorization result, the PoS machine notifies the cardholder of the transaction result. FIG. 3 is a schematic structural diagram of an online authorization request packet in existing qPBOC. It may be learned from FIG. 3 that, the authorization request packet includes an ARQC, an online PIN, and other transaction-related information. The online PIN is entered on a PoS machine.

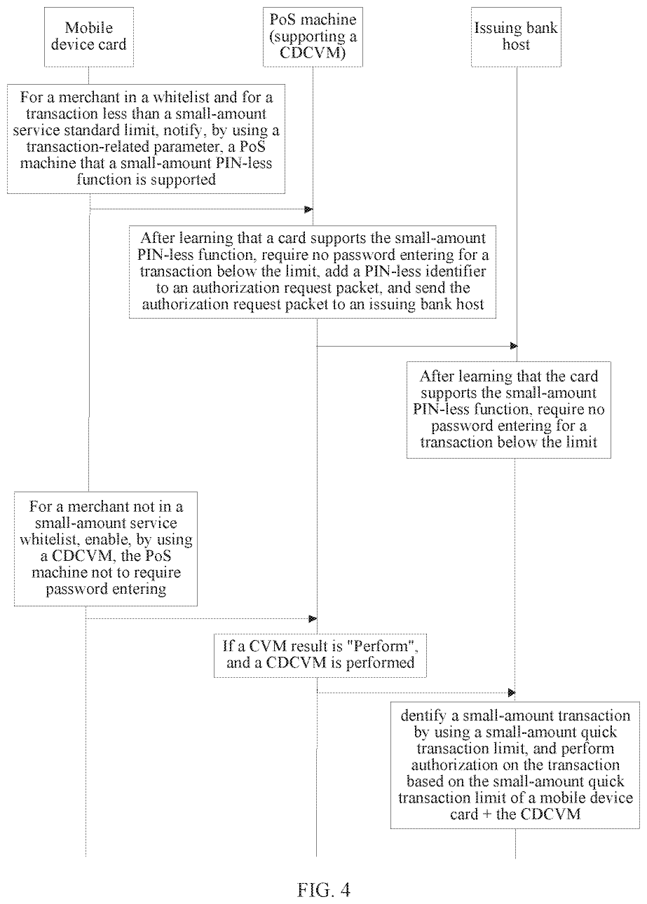

FIG. 4 is a schematic flowchart of a small-amount PIN-less transaction performed by using an existing mobile device card. Mobile device card payment is SE-based mobile payment, that is, a card required for a transaction is bound to a mobile device. Such a card is also referred to as a mobile device card, and functions such as payment of the card bound to the mobile device (for example, a mobile phone) may be completed by using the mobile device. As shown in FIG. 4, an existing offline mobile device PIN-less transaction is for a merchant in a whitelist. For a transaction that is less than or equal to a small-amount service standard limit and that is performed by the merchant in the whitelist, the mobile device notifies a PoS machine of a related parameter of the card for the transaction, the PoS machine reads related information of the card, and learns that the mobile device card supports a small-amount PIN-less function. However, after learning that the mobile device card supports the small-amount PIN-less function, the PoS machine does not require, based on a value relationship between a transaction amount and the PIN-less limit, password entering for a transaction whose transaction amount is less than or equal to the PIN-less limit. That is, the PoS machine does not perform cardholder identity verification, and adds a PIN-less identifier to an authorization request packet, and sends the authorization request packet to an issuing bank host. The authorization request packet includes an ARQC sent by the mobile device card. When the transaction is sent to the issuing bank host for authorization, the issuing bank host identifies a small-amount quick service based on the PIN-less identifier, and determines that the transaction is a small-amount PIN-less transaction.

For a merchant that is not in the whitelist but whose PoS machine supports a CDCVM, the CDCVM is selected as an implementation of a CVM, that is, a process of verifying an online password of the card is omitted, and subsequently, the PoS machine records that the CDCVM is performed for this transaction, and requests the issuing bank host to perform PIN-less authorization on this transaction. The issuing bank host identifies a small-amount transaction by using a small-amount quick transaction limit, and performs authorization on the transaction based on the small-amount quick transaction limit of the mobile device card and the CDCVM.

For an existing offline PIN-less transaction, there is no cardholder verification manner performed based on a second device, for example a wearable device. In addition, for small-amount PIN-less HCE Cloud QuickPass based on the mobile device card, in consideration of security, some issuing banks do not consider a CDCVM in an HCE software environment is a trusted CDCVM, and as a result, the CDCVM is not added to a CVM list of a Cloud QuickPass card.

When the PoS machine supports the small-amount PIN-less function, an HCE application can perform a small-amount PIN-less transaction without performing identity verification. In this case, information about an HCE card is easily thieved by Trojan or after the mobile phone is lost, unauthorized payment may be performed. When the PoS machine and/or an HCE payment application do/does not support the small-amount PIN-less function, a password always needs to be entered when a transaction is performed by swiping an HCE card (including a credit card), and therefore, there is a risk that the password is peeked at or thieved when the password is altered on the PoS machine.

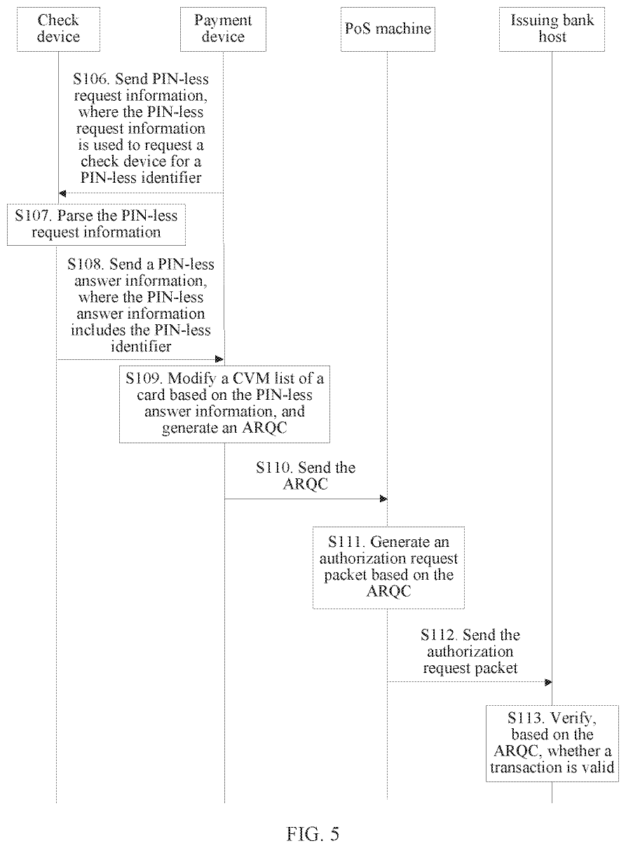

Based on a security problem that exists in an existing HCE Cloud QuickPass PIN-less transaction, an embodiment of the present invention provides a transaction method. FIG. 5 is a schematic flowchart of the transaction method 100 according to this embodiment of the present invention. The transaction method according to this embodiment of the present invention is described below with reference to FIG. 5. It should be understood that, this embodiment of the present invention is described by using only the transaction method shown in FIG. 5 as an example in, but this embodiment of the present invention is not limited thereto.

Primary bodies used in the transaction method in this embodiment of the present invention include: a payment device, a check device, a PoS machine, and a server.

The payment device may be a mobile phone, and correspondingly, the check device may be a wearable device; or the payment device may be a wearable device, and correspondingly, the check device may be a mobile phone. The server may be an issuing bank host. For example, for a cardholder, a used mobile phone may be the payment device, and a carried-on watch may be the check device; or a used mobile phone may be the check device, and a carried-on watch may be the payment device. The wearable device may include but is not limited to: a watch supported by a wrist, for example, a smartwatch and a smart band; footwear supported by feet, for example, smart sneakers; and glasses supported by a head, for example, smart glasses and a smart helmet. The payment device is also not limited to a mobile phone, and may be a device provided that the device can complete a payment function. This is not limited in this embodiment of the present invention.

As shown in FIG. 5, the method 100 includes the following steps.

S106. A payment device sends PIN-less request information to a check device, where the PIN-less request information is used to request the check device for a PIN-less identifier, the PIN-less identifier is used to indicate that a card for a transaction has a PIN-less capability, the PIN-less identifier is associated with the check device and corresponds to the card, and the payment device, the check device, and the card are already associated with each other.

Specifically, when a transaction needs to be performed, the payment device sends the PIN-less request information to the check device, to apply for the PIN-less identifier from the check device. The PIN-less identifier is used to indicate that the card for the transaction has the PIN-less capability, so that an issuing bank host can learn that the card for the transaction has the PIN-less capability. The PIN-less identifier corresponds to the card, and is stored in the check device and associated with the check device, but is not directly associated with the payment device. In this way, it is avoided that the PIN-less identifier is associated with the payment device, so that the check device can perform identity verification on a holder of the payment device in a transaction. Correspondingly, the check device receives the PIN-less request information sent by the payment device. The issuing bank host determines, based on the PIN-less identifier, that the card has a PIN-less capability.

It should be understood that, the PIN-less request information may include information about the card required for the transaction. For example, the PIN-less request information may be an identifier of the card and used to indicate, to the check device, which card is required for a current transaction. Then, a subsequent operation is performed on the card. The PIN-less request information may further include a random number of the payment device. The random number may be an ATC and is used to further ensure validity and security of the transaction. The PIN-less request information may further include other information or data related to this transaction. This is not limited in this embodiment of the present invention.

It should be further understood that before the transaction starts, the payment device, the check device, and the card are already associated with each other. When selecting the card required for the transaction and detecting the check device, the payment device generates the PIN-less request information and sends the PIN-less request information to the associated check device.

It should be further understood that, the PIN-less capability of the card may be a PIN-less capability within a particular limit. This is not limited in this embodiment of the present invention.

S107. The check device parses the PIN-less request information.

S108. The check device sends PIN-less answer information to the payment device in response to the PIN-less request information, where the PIN-less answer information includes the PIN-less identifier, and the PIN-less answer information is used by the payment device to modify a cardholder verification method CVM list of the card.

Specifically, after the check device receives the PIN-less request information, and because previously, the check device is already bound to the payment device, the check device parses the PIN-less request information and determines validity of the PIN-less request information. For example, whether the PIN-less request information is sent by the payment device bound to the check device, whether the card required for the transaction is real and valid, and the like are determined by using some identification information that is negotiated when the check device is bound to the payment device. After determining that the information is valid, the check device sends the PIN-less answer information to the payment device in response to the PIN-less request information.

Correspondingly, the payment device receives the PIN-less answer information. For a cardholder, both the check device and the payment device are carried along by the cardholder, and therefore, the process may be considered as verifying an identity of the cardholder. The PIN-less answer information includes the PIN-less identifier. In this way, the PIN-less identifier is stored in the check device and used as a second factor for identity verification of the payment device in the transaction, and two-factor verification is implemented after the additional check device of the cardholder verifies the payment device. After the process is completed, the payment device may determine legality of the identity of the cardholder, to modify the cardholder verification method list of the card.

Optionally, the PIN-less answer information may further include a PIN-less limit corresponding to the PIN-less identifier, and the PIN-less limit is used to define an amount of a PIN-less permission, so that the card may be PIN-less for a transaction below the corresponding PIN-less limit. The PIN-less limit may be sent by the issuing bank host to the check device, and when the PIN-less request information includes a random number of the payment device, the PIN-less answer information should also include the random number, to further ensure validity and security of the transaction. This is not limited in this embodiment of the present invention.

It should be understood that, the PIN-less answer information may further include other information or data related to this transaction. This is not limited in this embodiment of the present invention.

S109. The payment device modifies a cardholder verification method CVM list of the card based on the PIN-less answer information, so then a PoS machine learns that the transaction is a PIN-less transaction.

The payment device generates an authorization request cryptogram based on the PIN-less answer information, where the authorization request cryptogram includes the PIN-less identifier.

Specifically, in S109, after successfully receiving the PIN-less answer information, the payment device determines that the PIN-less answer information is valid, that is, determines the legality of the identity of the cardholder. According to this method, the identity of the cardholder may be identified by using the check device held by the holder. Still further, the check device and the payment device may verily each other. After learning that the check device has a valid PIN-less permission, the payment device modifies the cardholder verification method CVM list of the card, and returns the modified CVM list of the card to the PoS machine in an instruction (SELECT). An objective of modifying the CVM list of the card is to make the PoS machine learn that this transaction is PIN-less, and password verification is not performed on the PoS machine, that is, a user does not need to provide a password. The password is used to verify the identity of the cardholder on the issuing bank host. Because a previous process in which the payment device requests the check device for the PIN-less identifier may already be considered as verifying the identity of the cardholder, a step of entering a password on the PoS machine does not need to be performed in actual use. That a password does not need to be entered means that the identity of the cardholder does not need to be additionally verified, that is, a CVM step in a PBOC procedure no longer needs to be performed.

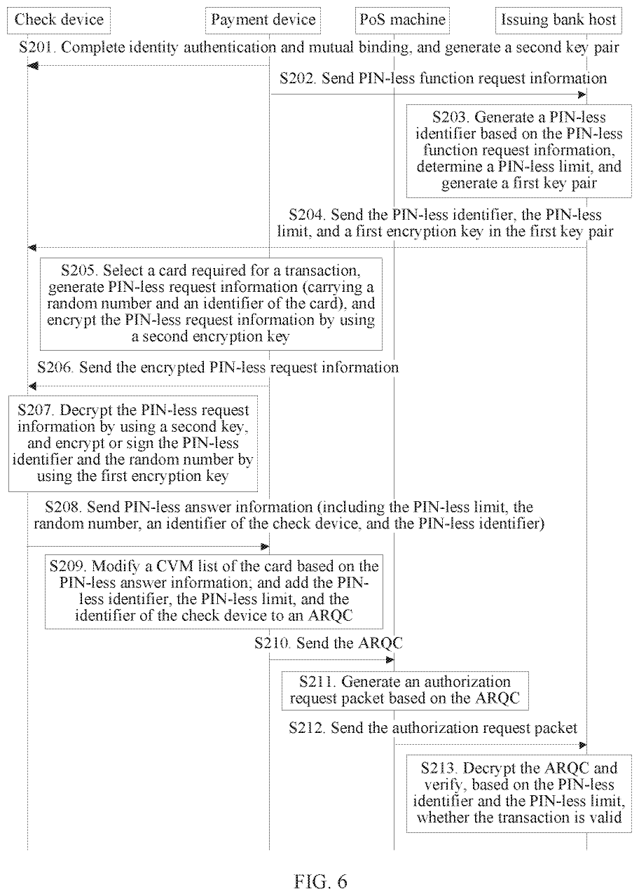

S109 of modifying, by the payment device, a CVM list of the card may be consistent with S209 in a schematic flowchart of a transaction method 200 according to another embodiment of the present invention shown in FIG. 6.

Optionally, in an embodiment, the modifying, by the payment device, a CVM list of the card may include: setting, in the CVM list of the card, a service condition of an online personal identification number PIN to be that a transaction amount is greater than a PIN-less limit, where the PIN-less limit corresponds to the PIN-less identifier.

Specifically, an objective of modifying the CVM list of the card is to make the PoS machine learn that this transaction is PIN-less and a password does not need to be verified on the PoS machine. Finally, the PoS machine performs a CVM supported by both the card and the CVM list of the PoS machine. Table 1 is a data table of the card and includes some parameters in the CVM list of the card. It may be found that, in a normal CVM type, online PIN verification is used first, and therefore, in the CVM list of the card, the payment device sets a service condition of the online PIN verification to be that the transaction amount is greater than the PIN-less limit. In this way, when the CVM is finally performed, only the CVM list of the card is modified, and therefore, the CVM supported by both the card and the PoS machine is selected. Therefore, when the transaction amount is less than or is equal to the PIN-less limit, a transaction does not satisfy the condition of using an online PIN, and therefore, a signature or another CVM without password entering is selected for implementing a PIN-less function.

TABLE 1
Data table of card

| Data element | Description |
|---|---|
| Application | Used to determine whether a specified currency in a card is used for a |
| currency code | transaction. If a CVM list exists and an amount X or an amount Y in the |
| | CVM list is not zero, application currency code data exists in the card. |
| Application | Including an indicator, which indicates whether the card supports cardholder |
| interchange profile | verification. The indicator needs to be set to “1”. |
| CVM list | A cardholder verification method list with a sequence. The card may include |
| | a list of a plurality of cardholder verification methods to be used in different |
| | environments. A cardholder verification method list includes the following |
| | parts: |
| | Amount X: an amount that may be used in a service condition of a cardholder |
| | verification method; |
| | Amount Y: a second amount that may be used in the service condition of the |
| | cardholder verification method; |
| | Cardholder verification method entry: The cardholder verification method list |
| | may include more than one entry, and each entry includes the following |
| | subfields: |
| | Subfield: |
| | CVM code: used to indicate, if a CVM fails, to perform a next CVM or |
| | consider that the CVM fails. |
| | CVM type: |
| | The CVM type includes: offline plaintext PIN verification; |
| | offline encrypted PIN verification; |
| | offline plaintext PIN verification and a signature; |
| | a signature; |
| | no need of a CVM (considering that the CVM |
| | succeeds); |
| | a failure of CVM processing (considering that the |
| | CVM fails); and |
| | showing an ID card. |
| | Service conditions of a CVM: |
| | The service conditions of the CVM include: always performing; |
| | if a transaction is a cash or a |
| | cashback transaction; |
| | if a transaction is not a cash or a |
| | cashback transaction; |
| | If support of the CVM is |
| | interrupted; |
| | if a transaction amount is less |
| | than the amount X; |
| | if a transaction amount is greater |
| | than the amount X; |
| | if a transaction amount is less |
| | than the amount Y; or |
| | if a transaction amount is greater |
| | than the amount Y. |

Note:
the last four service conditions of the CVM require that a card-specified currency (which is a card application currency) is used for a transaction.

It should be understood that, the PIN-less limit may be carried in the PIN-less answer information and obtained by the payment device by parsing the PIN-less answer information, or may be obtained by the payment device in another manner. For example, the PIN-less limit may be sent by the issuing bank host to the payment device, and the payment device stores the PIN-less limit. This is not limited in this embodiment of the present invention.

Optionally, in an embodiment, the modifying, by the payment device, a CVM list of the card may further include: adding a device cardholder verification method CDCVM to a CVM type in the CVM list of the card, and recording a result of the CDCVM as that verification succeeds.

Specifically, because the payment device successfully receives the PIN-less answer information, that is, identity verification is already performed on the payment device and legality of an identity of a user of the payment device is confirmed, it may be considered that CDCVM verification is already performed on the payment device, and the verification of the identity of the cardholder succeeds. It may be learned from the foregoing descriptions then the PoS machine finally performs the CVM that is supported by both the card and the CVM list of the PoS machine. Therefore, a service condition of the modification manner is then the PoS machine also needs to support the CDCVM, and the transaction amount needs to be less than or is equal to the PIN-less limit. As shown in Table 1, there is also a CDCVM in the CVM type of the CVM list of the PoS machine. Therefore, if the PoS machine also supports the CDCVM, the modification manner may be used. When the PoS machine determines that the transaction amount is less than or is equal to the PIN-less limit, and determines that the CDCVM is valid (satisfying a service condition of a limit condition), the CDCVM is used as a cardholder verification manner for this transaction, and a password is not verified on the PoS machine. How ever, when the transaction amount is greater than the PIN-less limit, a password is verified in a password verification manner of entering an online PIN.

Optionally, in an embodiment, the modifying, by the payment device, a CVM list of the card may further include: setting, in the CVM list of the card, as shown in Table 1, a service condition of an online personal identification number PIN to be that a transaction amount is greater than a PIN-less limit, adding a device cardholder verification method CDCVM to a CVM type in the CVM list of the card, and recording a result of the CDCVM as that verification succeeds.

Specifically, an interaction time between the card and the PoS machine that is specified by qPBOC is very short and is usually between 0.3 s to 0.5 s. Therefore, a measure of modifying a CVM of the card is performed before the card interacts with the PoS machine, and after the CVM of the card is modified, the card enters a PIN-less state and then interacts with the PoS machine. Therefore, in this case, a CVM attribute of the PoS machine is unknown, that is, it is unknown whether the PoS machine supports the CDCVM. In these two modification manners, whether the PoS machine supports the CDCVM does not need to be considered. Therefore, such a modification manner can cover an entire application scenario, and when it is determined that the transaction amount is less than or is equal to the PIN-less limit, the modification manner may be used, so then the PoS machine learns that the transaction is PIN-less.

It should be further understood that, the method of modifying, by the payment device, the CVM of the card may further include: setting an application interchange profile (application interchange profile. AIP) of the card as not supporting the CVM. As shown in Table 1, that is, the CVM step does not need to be performed. The AIP of the card indicates that in this application, the card supports a capability list of a specified function, including static data authentication (static data authentication, SDA), dynamic data authentication (dynamic data authentication, DDA), cardholder verification, issuing bank verification, and combined dynamic data authentication/application cryptogram (combined dynamic data authentication/application cryptogram, DDA/AC). A service premise of the modification manner is that the transaction amount (the authorization amount) is determined to be less than or equal to the PIN-less limit. In addition, when the modification manner is used, indication information needs to be added to the ARQC generated by the payment device. The indication information is used to: notify the issuing bank host that CVM verification is performed for this transaction, and request the issuing bank host to perform authorization on the transaction based on the CVM. In this way, after the PoS machine detects that the AIP of the card does not support the CVM, the CVM does not need to be performed. Therefore, in this transaction, the CVM step in the PBOC procedure is actually not performed. After receiving the indication information, the issuing bank host knows that the transaction is verified by the check device and then performs PIN-less authorization on the transaction with reference to the PIN-less permission of the card.

It should be further understood that, in this embodiment of the present invention, the method for modifying the CVM of the card may further include another modification manner, provided that in the modification manner, the PoS machine learns that this transaction is PIN-less and a password entering operation does not need to be performed on the PoS machine. This is not limited in this embodiment of the present invention.

In S109, the payment device generates an authorization request cryptogram ARQC based on the PIN-less answer information, where the ARQC includes the PIN-less identifier, and the payment device sends the ARQC to the PoS machine in a GPO response. However, before this, the PoS machine attaches the transaction amount, other transaction information related to the transaction, and a terminal transaction attribute of the PoS machine to a GPO instruction and notifies the payment device of the GPO instruction, so that the payment device performs a risk management check, determines a transaction type (offline completion/online authorization/transaction rejection), and generates the ARQC. The terminal transaction attribute of the PoS machine includes the CVM list of the PoS machine, and the payment device returns, to the PoS machine, the modified CVM list of the card in a response to a previous instruction (SELECT) of the GPO. After sending the ARQC to the PoS machine and completing the response to the GPO instruction, the payment device may leave an induction area of the PoS machine.

It should be understood that, the payment device may further add the PIN-less limit, an identifier of the payment device, and other information and data related to this transaction to the ARQC. When the PIN-less answer information includes the random number, the payment device may also add the random number to the ARQC, to further ensure security of the transaction. This is not limited in this embodiment of the present invention.

S110. The payment device sends the ARQC to the PoS machine, where the ARQC is used by the PoS machine to generate an authorization request packet and send the authorization request packet to an issuing bank host for the transaction, and the authorization request packet includes the ARQC.

Specifically, the payment device sends the ARQC to the PoS machine in the GPO response, and the authorization request cryptogram is used by the PoS machine to generate the authorization request packet and send the authorization request packet to the issuing bank host.

S111. The PoS machine adds the ARQC and related transaction information to the authorization request packet.

Specifically, the PoS machine adds the ARQC to the authorization request packet, and sends the authorization request packet to the issuing bank host. The authorization request packet may further include other information of this transaction, for example, the transaction amount. This is not limited in this embodiment of the present invention.

S112. The PoS machine sends the authorization request packet to the issuing bank host. Correspondingly, the issuing bank host receives the authorization request packet sent by the PoS machine. The authorization request packet includes the ARQC, and the ARQC includes the PIN-less identifier that is associated with the check device and that corresponds to the card required for the transaction. The PIN-less identifier is used to make the issuing bank host learn that the card has a PIN-less capability within the PIN-less limit. The payment device, the check device, and the card are already associated with each other.

Specifically, in S112, after the PoS machine interacts with the payment device, the issuing bank host receives the authorization request packet sent by the PoS machine. The authorization request packet includes the ARQC, and the ARQC includes the PIN-less identifier that is associated with the check device and that corresponds to the card required for the transaction. The PIN-less identifier is used to make the issuing bank host learn that the card has the PIN-less capability. The PIN-less identifier is a PIN-less identifier corresponding to the card required for the transaction. The PIN-less identifier is associated with the check device but is not directly associated with the payment device. In such a method, the identity of the cardholder can be identified by using the held check device. Still further, the check device and the payment device may verify each other, and a cardholder identify verification function is provided.

S113. The issuing bank host verifies, based on the ARQC, whether the transaction is valid.

Specifically, in S113, when decrypting the ARQC in the authorization request packet and detecting that the ARQC includes the PIN-less identifier, the issuing bank host extracts the PIN-less identifier, and when determining that the PIN-less identifier is valid and the transaction amount is less than or is equal to the PIN-less limit, determines the PIN-less transaction permission is valid, and performs authorization on the transaction. Alternatively, when decrypting the ARQC and determining that the PIN-less identifier is invalid, the issuing bank host rejects the transaction. In this case, the issuing bank host freezes or cancels the binding relationship between the card and the check device, cancels a PIN-less function of the check device, and instructs the card/the payment device to perform corresponding processing (which includes no longer sending a PIN-less request or re-applying for/re-updating the PIN-less identifier). Alternatively, when the issuing bank host determines that the transaction amount is greater than the PIN-less limit, an online password carried in the authorization request packet needs to be verified, to determine whether authorization is performed on the transaction. The PIN-less limit may be determined and stored when the issuing bank host generates the PIN-less identifier.

It should be understood that sequence numbers of the foregoing processes do not mean execution sequences in various embodiments of the present invention. The execution sequences of the processes should be determined according to functions and internal logic of the processes, and should not be construed as any limitation on the implementation processes of the embodiments of the present invention.

Therefore, according to the transaction method in this embodiment of the present invention, the check device is introduced for verification, security of an HCE transaction is enhanced, and two-factor verification is implemented after the payment device and the additional check device verify each other. In this way, even if the payment device is lost or information about the card is thieved, because the check device further needs to be verified for a small-amount PIN-less transaction, unauthorized payment is not performed. In addition, for a PoS machine and/or an HCE payment application not supporting a small-amount PIN-less function, validity of verifying a PIN-less permission of the check device is used, and after the PIN-less identifier is verified and the payment device modifies the CVM list of the card after receiving a response of the check device, the PIN-less functions of the PoS machine and the issuing bank host are implemented, so that small-amount PIN-less payment is implemented, a password entering operation no longer needs to be performed, and a risk that a password is peeked at when the password is entered is avoided, thereby achieving higher security and better user experience.

FIG. 6 is a schematic flowchart of a transaction method 200 according to another embodiment of the present invention. As shown in FIG. 6, steps S206 to S213 of the transaction method 200 are similar to steps S106 to S113 of the transaction method 100, and details are not described herein again.

Before S206, the method 200 may further include the following steps.

S201. The payment device performs mutual verification on and binding with the check device, and generates a second key pair through negotiation, where the second key pair includes a second encryption key and a second decryption key.

Specifically, before a transaction is started, the payment device first exchanges information with the check device and performs binding, and generates the second key pair. The second key pair is used for subsequent authentication on identities of the payment device and the check device and encryption of the information exchanged between the two devices. In this way, security of the transaction can be enhanced.

It should be understood that, the second key pair may be symmetric, that is, the second encryption key and the second decryption key included in the second key pair are the same. Alternatively, the second key pair may be asymmetrical, that is, the second encryption key and the second decryption key are different. In this case, the second key pair may include the second encryption key and the second decryption key. This is not limited in this embodiment of the present invention.

It should be further understood that, the second key pair is merely for describing a key pair used when encryption needs to be performed, and should not constitute any limitation on this embodiment of the present invention. The identities of the payment device and the check device may be verified in another manner. This is not limited in this embodiment of the present invention.

S202. The payment device sends PIN-less function request information to the issuing bank host, where the PIN-less verification request information is used to request the PIN-less identifier for the check device, so that the issuing bank host generates the PIN-less identifier based on the PIN-less verification request information, determines the PIN-less limit corresponding to the PIN-less identifier, and sends the check device to the PIN-less identifier.

Specifically, after the payment device and the check device complete mutual authentication, the payment device stores information of the check device. Because the payment device is already bound to the card, a user may send the PIN-less verification request information to the issuing bank host by using a related payment application program on the payment device or a related option on a payment application program. The related option may be binding to a third-party device (the check device), and the like. Correspondingly, the issuing bank host receives the PIN-less function request information. The PIN-less function request information is used to apply for a PIN-less verification function of the check device from the issuing bank host, that is, request the PIN-less identifier for the check device. In this way, the issuing bank host enables two-factor PIN-less verification functions of the payment device and the check device, the payment device on a payment end and the check device on an authentication end are separated, and the payment device is verified by using the additional check device, so that security of a transaction can be enhanced.

It should be understood that, the PIN-less function request information may include information about the card and may be, for example, an identifier of the card. The PIN-less function request information is used by the issuing bank host to verify the information about the card and bind the card to the check device. In this way, the issuing bank host may generate the PIN-less identifier associated with the check device, and determine the PIN-less limit corresponding to the PIN-less identifier, and other information related to the transaction.

Optionally, the payment device may alternatively send information about a plurality of cards to the issuing bank host. The information is used by the issuing bank host to bind each card to the check device. Correspondingly, the issuing bank host may alternatively receive the information about the plurality of cards, generate a PIN-less identifier corresponding to each card and a PIN-less limit corresponding to the PIN-less identifier, and send the PIN-less identifiers to the check device. In this way, in a transaction, the check device may select, based on the PIN-less request information, the PIN-less identifier corresponding to the card from the PIN-less identifiers, to perform a subsequent operation. This is not limited in this embodiment of the present invention.

It should be understood that, the payment device may further send information about the check device or other information related to the transaction to the issuing bank host. For example, the information may be information such as an identifier of the check device and an identifier of the payment device. This is not limited in this embodiment of the present invention.

S203. The issuing bank host receives the PIN-less verification request information sent by the payment device.

The issuing bank host generates the PIN-less identifier based on the PIN-less verification request information, and determines the PIN-less limit corresponding to the PIN-less identifier.

S204. The issuing bank host sends the PIN-less identifier to the check device.

Specifically, after receiving the PIN-less verification request information sent by the payment device, the issuing bank host may enable the PIN-less verification function of the check device, and after determining, based on content such as an identifier of the card included in the PIN-less verification request information, that the card is valid, bind the card to the check device. Because the card is previously bound to the payment device, the payment device, the card, and the check device are bound to each other. The issuing bank host may generate the PIN-less identifier that is associated with the check device and that corresponds to the card, and determine the PIN-less limit corresponding to the PIN-less identifier. After storing the PIN-less identifier and the PIN-less limit, the issuing bank host sends the PIN-less identifier to the check device. The PIN-less identifier is stored in the check device, and the PIN-less identifier and the information about the card in the payment device are separately stored. For each subsequent transaction of a user, when the user selects, on the payment device, a card required for the transaction, because the payment device and the check device are already associated, and the PIN-less identifier that is associated with the payment device and that corresponds to the card required for the transaction is stored in the check device, the user further needs to apply, from the check device, for the PIN-less identifier corresponding to the card for the transaction. Only when the payment device obtains the PIN-less identifier, subsequent processing can be performed. This process may be considered as verifying whether an identity of the cardholder is legal. That is, a process of applying for the PIN-less identifier from the check device after a card is selected for each transaction may be considered as applying for authorization from the check device after the card is selected for each transaction. In this way, security of the transaction is enhanced.

Optionally, the PIN-less verification request information may further include an identifier of the check device. The identifier of the check device is used by the issuing bank host to verify the identity of the check device subsequently based on the identifier of the check device, and search for the PIN-less identifier. The PIN-less verification request information of the check device may further include other information related to the transaction. This is not limited in this embodiment of the present invention.

Optionally, the issuing bank host may further determine other information or data related to the transaction, and send the information or the data to the check device. For example, the information or the data may be a quantity of transactions. This is not limited in this embodiment of the present invention.

Optionally, as shown in FIG. 6, in S204, the issuing bank host may alternatively send the PIN-less limit to the check device. The PIN-less limit is used by the check device to generate the PIN-less answer information subsequently. This is not limited in this embodiment of the present invention.

Optionally, as shown in FIG. 6, in S203, the issuing bank host may further generate a first key pair, and the first key pair includes a first encryption key and a first decryption key. Correspondingly, in S204, the issuing bank host sends the first encryption key to the check device, and the first encryption key is used by the check device to encrypt or sign the PIN-less identifier.

Specifically, to further enhance security of a two-factor verification transaction, the issuing bank host may generate the first key pair. The first key pair is used to encrypt or sign the PIN-less identifier subsequently. The first key pair may be generated by the issuing bank host based on the PIN-less verification request information of the check device sent by the payment device. When the first key pair may be asymmetrical, that is, the first key pair includes the first encryption key and the first decryption key, the issuing bank host sends the first encryption key to the check device.

It should be understood that, the first key pair may be symmetrical, that is, the first encryption key and the first decryption key are totally the same. This is not limited in this embodiment of the present invention.

It should be further understood that, the first key pair is merely for describing a key pair used when the PIN-less identifier needs to be encrypted, that is, a method used for determining that the PIN-less identifier is valid, and should not constitute any limitation on this embodiment of the present invention. Alternatively, the issuing bank host and the check device may determine that the PIN-less identifier is valid by using another method. This is not limited in this embodiment of the present invention.

It should be further understood that, steps S201 to S204 may be performed in a preset preparation process, that is, performed before a transaction is started. In this way, the preset preparation steps do not need to be performed in each subsequent transaction.

S205. The payment device generates the PIN-less request information, where the PIN-less request information is used to request the check device for the PIN-less identifier, and the payment device, the check device, and the card are associated with each other.

Specifically, when the user needs to perform a transaction, the user selects a card required for the transaction on the payment device, where the card may be one or more of cards registered with the issuing bank host and already associated with the check device. Because the payment device and the check device are already associated, after the payment device detects the check device, to further confirm accuracy of the transaction, for example, there may be a case in which some users do not want to perform a transaction but only wants to check the card bound to the payment device, the payment device incorrectly considers that the user needs to perform the transaction and generate the PIN-less request information, after the user confirms that a transaction is needed, the payment device automatically or manually generates the PIN-less request information, to avoid such a case.

Optionally, as shown in FIG. 6, in S205, the PIN-less request information may include a random number of the payment device and an identifier of the card. The identifier of the card is used by the check device to find related information such as the PIN-less identifier associated with the card and a parameter.

Optionally, as shown in FIG. 6, in S205, to enhance security of an entire payment process, the payment device may encrypt the PIN-less request information by using the second encryption key in the second key pair. Correspondingly, in S206, the payment device may send the PIN-less request information encrypted by using the second encryption key in the second key pair. The second key pair is generated through negotiation between the payment device and the check device, and the second key pair includes the second encryption key and a second decryption key;

Specifically, to further verify the payment device and the check device and enhance security of payment, the payment device may encrypt the PIN-less request information by using the second encryption key in the second key pair, and send the encrypted PIN-less request information to the check device. Correspondingly, the check device receives the encrypted PIN-less request information, and verifies validity of the PIN-less request information by using the second decryption key. Correspondingly, the check device may further encrypt the PIN-less answer information by using the second encryption key; and the payment device may further decrypt the PIN-less answer information by using the second decryption key, so that security of a transaction may be further enhanced, and unauthorized payment performed for a small-amount PIN-less transaction is avoided when the payment device is lost.

It should be understood that, in this embodiment of the present invention, encrypting the PIN-less request information by using the second encryption key is a method for enhancing security and completing mutual verification, that is, a method for performing mutual verification between the payment device and the check device. The method may alternatively be another method for mutual verification, and the second key pair may alternatively be any other key pairs that can complete identity verification, and should not constitute any limitation on this embodiment of the present invention.

It should be understood that, when the second key pair is symmetrical, that is, the second encryption key and the second decryption key are the same, in this case, the payment device may encrypt the PIN-less request information by using the second encryption key, and may further decry pt, by using the second decryption key, the PIN-less answer information in response to the PIN-less request information sent by the check device. When the second key pair is asymmetrical, the payment device may sign the PIN-less request information by using the second encryption key and verify, by using the second decryption key, the signature of the PIN-less answer information sent by the check device in response to the PIN-less request information. Further, authentication between the payment device and the check device is completed by processing the request/response information by using a key; This is not limited in this embodiment of the present invention.

It should be further understood that, the check device may verify whether an identity of a holder of the payment device is valid in another identity verification manner. For example, a user may set an initial password when the check device is bound to the payment device, and subsequently, when the payment device requests the check device for the PIN-less identifier, the check device may require the user to enter the initial password, and verify the identity of the holder of the payment device by using the initial password. If the check device is a wearable device, for example, a smart band, the identity verification manner may alternatively be a manner in which the check device protects the PIN-less identifier by using a biometrical identification technology such as an initial password+carry-on state detection and pulse detection. That is, the user does not need to verify the identity of the holder of the payment device in a verification manner actively operated by the user. This is not limited in this embodiment of the present invention.

Optionally, as shown in FIG. 6, in S207, the check device decrypts the PIN-less request information by using the second decryption key, and encrypts or signs the PIN-less identifier by using the first encryption key.

Specifically, when the PIN-less request information performs encryption by using the second encryption key, the check device verify validity of the PIN-less request information by using the second decryption key, thereby enhancing security of identity verification performed between the check device and the payment device. In addition, to further enhance security of a transaction, before sending the PIN-less answer information, the check device may encrypt or sign the PIN-less identifier by using the first encryption key in the first key pair. When the first key pair is symmetrical, that is, the first encryption key and the first decryption key are totally the same, the PIN-less identifier may be encrypted by using the first encryption key in the first key pair. When the first key pair is asymmetrical, that is, the first encryption key and the first decryption key are different, the PIN-less identifier may be signed by using the first encryption key in the first key pair. The first key pair may be generated by the issuing bank host based on the request information that is used to enable the PIN-less function of the check device and that is sent by the payment device. The check device receives the first key pair sent by the issuing bank host. Correspondingly, the issuing bank host may determine, based on the first decryption key, whether the PIN-less identifier is real and valid. In this way, the check device processes the PIN-less identifier by using the first key pair, to complete authentication between the check device and the issuing bank host and further improve security of the transaction.

It should be understood that, in this embodiment of the present invention, in the PIN-less answer information, in addition to the PIN-less identifier that may be encrypted or signed by using the first encryption key, other information, for example, the PIN-less limit, the random number, and the information about the card may also be encrypted or signed by using the first encryption key. This is not limited in this embodiment of the present invention.

It should be further understood that, the first key pair and the first encryption key are only used to indicate that the PIN-less identifier needs to be encrypted, and in this embodiment of the present invention, the PIN-less identifier may be encrypted in another encryption manner. The first key pair and the first encryption key should not constitute any limitation on this embodiment of the present invention.

Optionally, as shown in FIG. 6, in S208, when the PIN-less request information may include a random number of the payment device, the PIN-less answer information should also include the random number of the payment device. The random number may be an ATC, used to further ensure validity and security of the transaction. The PIN-less answer information may further include an identifier of the check device and the PIN-less limit. The identifier of the check device is used by the issuing bank host to determine an identity of the check device and search for the PIN-less identifier. It should be understood that, the PIN-less answer information may further include other information or data related to this transaction. This is not limited in this embodiment of the present invention.

Optionally, as shown in FIG. 6, in S208, when the PIN-less answer information further includes the identifier of the check device, in S209, the payment device may determine that the PIN-less answer information is valid by verifying the identifier of the check device, and modify the CVM list of the card based on the identifier of the check device and the PIN-less limit.

Optionally, as shown in FIG. 6, in S209, when the PIN-less answer information includes the random number of the payment device, the ARQC should also include the random number of the payment device. The ARQC may include information such as the PIN-less limit and the identifier of the check device. This is not limited in this embodiment of the present invention.

Optionally, in S209, the authorization request cryptogram may include one or more of information of: an unpredicted number related to the transaction, issuer defined data (issuer defined data, IDD), a verification result of card risk management performed by the card based on a parameter such as a terminal transaction attribute provided by the PoS machine, the PIN-less limit, and the identifier of the check device. This is not limited in this embodiment of the present invention. For example, if the PoS machine also supports a CDCVM, the payment device performs CDCVM verification in advance, and then adds a CDCVM verification result to the authorization request cryptogram returned to the PoS machine in an interaction process between the PoS machine and the payment device. For example, the result may be that the CDCVM is performed and verification succeeds. The authorization request cryptogram may include other information or data related to this transaction, for example, a risk management parameter and a quantity of transactions that are set in the card.

Optionally, the authorization request cryptogram may further include other information or data related to this transaction. This is not limited in this embodiment of the present invention.

Optionally, when the PIN-less answer information includes the random number of the payment device, the authorization request cryptogram should also include the random number of the payment device.

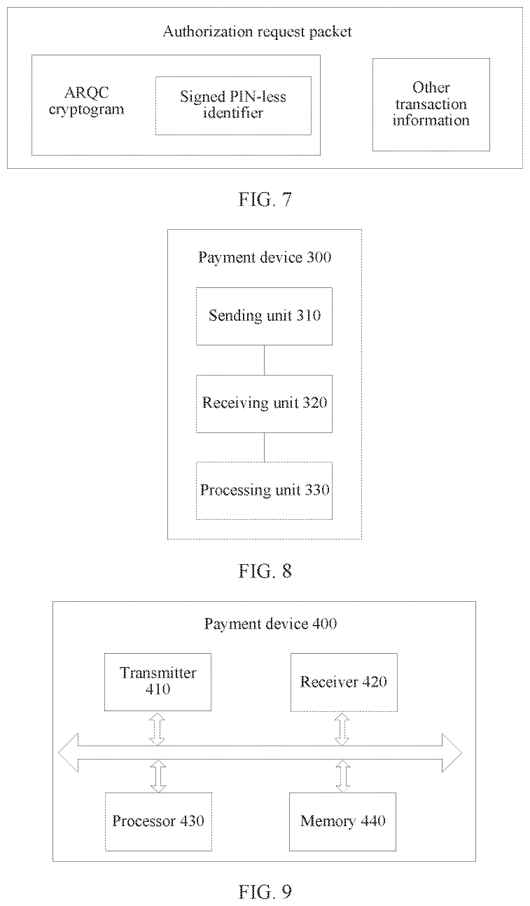

Optionally, FIG. 7 is a schematic diagram of a structure of the authorization request packet according to an embodiment of the present invention. It may be learned from FIG. 7 that, the authorization request packet includes the authorization request cryptogram and other information about the transaction. The authorization request cryptogram includes the PIN-less identifier signed by using the first encryption key. The authorization request packet may further include other information or data related to this transaction. This is not limited in this embodiment of the present invention.

Optionally, when the PIN-less identifier is encrypted or signed by using the first encryption key, in S213, the issuing bank host may determine, by using the first decryption key in the first key pair, whether the PIN-less identifier is valid, to verify the transaction.

Specifically, the issuing bank host decrypts the authorization request cryptogram, and when the issuing bank host detects that a corresponding field in the cryptogram includes data related to the transaction, for example, IDD, it is certified that the authorization request cryptogram includes the PIN-less identifier. Then, based on the identifier of the check device and the association relationship between the PIN-less identifier and the check device, the first decryption key and PIN-less permission information such as the PIN-less limit corresponding to the PIN-less identifier are found, and whether the PIN-less identifier is valid is verified by using the first decryption key. For example, whether the PIN-less identifier is tampered with and whether the PIN-less limit changes are detected. When it is determined that the PIN-less identifier is valid, and when the transaction amount is less than or is equal to the PIN-less limit, it is determined that the transaction is valid and password verification does not need to be performed.

Alternatively, when the issuing bank host detects that a corresponding field in the cryptogram does not include data related to the transaction, it is certified that the authorization request cryptogram does not include the PIN-less identifier, and in this case, a password verification operation needs to be performed. Alternatively, when the PIN-less identifier is detected, the first decryption key and PIN-less permission information such as the PIN-less limit corresponding to the PIN-less identifier are found based on the identifier of the check device and the association relationship between the PIN-less identifier and the check device, and when the PIN-less identifier is verified by using the first decryption key and it is determined that the PIN-less identifier is invalid, for example, the PIN-less identifier does not correspond to the card or the PIN-less identifier is tampered with, the issuing bank host rejects the transaction. Alternatively, when the PIN-less identifier is detected, and the PIN-less identifier is valid, and the transaction amount is greater than the PIN-less limit, it is determined that password verification needs to be performed for the transaction.

It should be understood that, in this embodiment of the present invention, the PIN-less limit may be set in the preset preparation process. For example, the PIN-less limit may be generated by the issuing bank host and stored in the issuing bank host after the issuing bank host receives the PIN-less verification request information of the check device. Alternatively, the PIN-less limit may be carried in the authorization request cryptogram and sent by the PoS machine to the issuing bank host, or may be obtained in another manner. This is not limited in this embodiment of the present invention.

It should be further understood that, the identifier of the check device may be stored by the issuing bank host when the check device and the card are bound to each other on the issuing bank host, or may be carried in a packet and sent to the issuing bank host by the PoS machine. This is not limited in this embodiment of the present invention.

It should be further understood that sequence numbers of the foregoing processes do not mean execution sequences in various embodiments of the present invention. The execution sequences of the processes should be determined according to functions and internal logic of the processes, and should not be construed as any limitation on the implementation processes of the embodiments of the present invention.

Therefore, according to the transaction method in this embodiment of the present invention, the check device is introduced for verification, security of an HCE transaction is enhanced, the PIN-less identifier and the PIN-less limit are stored in the check device registered with the issuing bank host and are used as a second factor of identity verification of the payment device in a transaction, two-factor verification is implemented after the payment device and the additional check device verify each other, a step of performing encryption by using the first key pair and the second key pair is added, and validity of a PIN-less permission of the check device is verified. In this way, even if the payment device is thieved or information about the card is disclosed, because the check device needs to be verified for a PIN-less transaction, unauthorized payment is not performed. For a PoS machine and/or an HCE payment application not supporting a small-amount PIN-less function, after the PIN-less identifier is modified and the payment device modifies the CVM list of the card after receiving a response of the check device, the PIN-less functions of the PoS machine and the issuing bank host are implemented, so that small-amount PIN-less payment is implemented, a password entering operation no longer needs to be performed, and a risk that a password is peeked at when a password is entered is avoided, thereby achieving higher security and better user experience. In addition, according to the transaction method in this embodiment of the present invention, the PoS machine does not need to be modified, technical difficulty and costs are low during implementation, and the method is easy to implement.

The transaction method according to the embodiments of the present invention are described in detail above with reference to FIG. 1 and FIG. 7, and a payment device, a check device, and a server according to the embodiments of the present invention are described in detail below with reference to FIG. 8 to FIG. 14.

FIG. 8 is a schematic block diagram of a payment device according to an embodiment of the present invention. It should be understood that the payment device embodiment corresponds to the method embodiment, and for similar descriptions, refer to the method embodiment. The payment device 300 shown in FIG. 8 corresponds to the payment device in FIG. 5 and FIG. 6. The payment device 300 includes:
a sending unit 310, configured to send PIN-less request information to a check device, where the PIN-less request information is used by the payment device to request the check device for a PIN-less identifier, the PIN-less identifier is used to indicate that a card for a transaction has a PIN-less capability, the PIN-less identifier is associated with the check device and corresponds to the card, and the payment device, the check device, and the card are already associated with each other;
a receiving unit 320, configured to receive PIN-less answer information that is sort by the check device in response to the PIN-less request information, where the PIN-less answer information includes the PIN-less identifier; and
a processing unit 330, configured to modify a cardholder verification method CVM list of the card based on the PIN-less answer information, so that a point of sale device PoS machine learns that the transaction is a PIN-less transaction, where
the processing unit 330 is further configured to generate an authorization request cryptogram ARQC based on the PIN-less answer information, and the sending unit 310 is further configured to send the ARQC to the PoS machine, w-here the ARQC includes the PIN-less identifier, the ARQC is used by the PoS machine to generate an authorization request packet and send the authorization request packet to a server for the transaction, and the authorization request packet includes the ARQC.

According to the payment device in this embodiment of the present invention, two-factor verification is implemented after the payment device and the additional check device verifies each other. In this way, even if the payment device is lost or information about the card is thieved, because the check device further needs to be verified for a small-amount PIN-less transaction, unauthorized payment is not performed. In addition, for a PoS machine and/or an HCE payment application not supporting a small-amount PIN-less function, validity of verifying a PIN-less permission of the check device is used, and after the PIN-less identifier is verified and the payment device modifies the CVM list of the card after receiving a response of the check device, the PIN-less functions of the PoS machine and the server are implemented, so that small-amount PIN-less payment is implemented, a password entering operation no longer needs to be performed, and a risk that a password is peeked at when the password is entered is avoided, thereby achieving higher security and better user experience.

Optionally, the payment device 300 may further include a storage unit 340, and the storage unit 340 may be configured to store code executed by the sending unit 310, the receiving unit 320, and the processing unit 330.

Optionally, in an embodiment, the processing unit 330 is specifically configured to: set, in the CVM list of the card, a service condition of an online personal identification number PIN to be that a transaction amount is greater than a PIN-less limit.

Optionally, in an embodiment, the processing unit 330 is specifically configured to: add a device cardholder verification method CDCVM to a CVM type in the CVM list of the card, and record a result of the CDCVM as that verification succeeds.

Optionally, in an embodiment, the sending unit 310 is further configured to: before the sending unit 310 sends the PIN-less request information to the check device, send PIN-less verification request information to the server, where the PIN-less verification request information is used to request the PIN-less identifier for the check device, so that the server generates the PIN-less identifier based on the PIN-less verification request information, determines the PIN-less limit corresponding to the PIN-less identifier, and sends the PIN-less identifier to the check device.

Optionally, in an embodiment, the check device encrypts or signs the PIN-less identifier received by the receiving unit 320 by using a first encryption key in a first key pair, where the first encryption key is sent by the server to the check device.

Optionally, in an embodiment, the sending unit 310 is specifically configured to send, to the check device, the PIN-less request information encrypted by using a second encryption key in a second key pair, where the second key pair is generated through negotiation between the payment device and the check device, and the second key pair includes the second encryption key and a second decryption key.

It should be understood that the payment device 300 according to this embodiment of the present invention may correspond to the payment device in the embodiments of the present invention, and the foregoing and other operations and/or functions of each unit of the payment device 300 implement a corresponding procedure of each method in FIG. 5 and FIG. 6. For brevity, details are not described herein again.

It should be noted that in an embodiment of the present invention, the sending unit 310 may be implemented by a transmitter, the receiving unit 320 may be implemented by a receiver, the processing unit 330 may be implemented by a processor, and the storage unit 340 may be implemented by a memory; As shown in FIG. 9, a payment device 400 may include a transmitter 410, a receiver 420, a processor 430, and a memory 440. The transmitter 410, the receiver 420, the processor 430, and the memory 440 in FIG. 9 communicate with each other, and transfer a control and/or data signal by using an internally connected channel. The memory 440 is configured to store program code, and the transmitter 410, the receiver 420, and the processor 430 are configured to invoke the program code to implement the methods in the foregoing embodiments of the present invention.

It should be understood that the payment device 400 shown in FIG. 9 may correspond to the payment device in the embodiments of the present invention, and the foregoing and other operations and/or functions of each unit of the payment device 400 implement a corresponding procedure of each method in FIG. 5 and FIG. 6. For brevity, details are not described herein again.

In an embodiment of the present invention, the processor 430 may be a central processing unit (central processing unit. CPU), a network processor (network processor, NP), or a combination of a CPU and an NP. The processor may further include a hardware chip. The hardware chip may be an application-specific integrated circuit (application-specific integrated circuit, ASIC), a programmable logic device (programmable logic device, PLD), or a combination thereof.

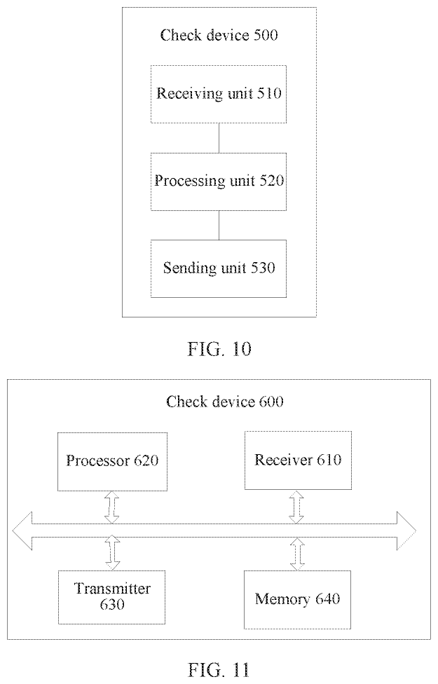

FIG. 10 is a schematic block diagram of a check device 500 according to an embodiment of the present invention. It should be understood that the check device embodiment corresponds to the method embodiment, and for similar descriptions, refer to the method embodiment. The check device 500 shown in FIG. 10 corresponds to the check device in FIG. 5 and FIG. 6. The check device 500 includes:
a receiving unit 510, configured to receive PIN-less request information sent by a payment device, where the PIN-less request information is used by the payment device to request the check device for a PIN-less identifier, the PIN-less identifier is used to indicate that a card for a transaction has a PIN-less capability, the PIN-less identifier is associated with the check device and corresponds to the card, and the payment device, the check device, and the card are already associated with each other;
a processing unit 520, configured to parse the PIN-less request information; and
a sending unit 530, configured to send, to the payment device, PIN-less answer information in response to the PIN-less request information, where the PIN-less answer information includes the PIN-less identifier, and the PIN-less answer information is used by the payment device to modify a cardholder verification method CVM list of the card.

According to the check device in this embodiment of the present invention, the PIN-less identifier is stored in the check device, and the PIN-less identifier and the information about the card in the payment device are separately stored. After a card is selected for each transaction, the check device is applied for authorization, and two-factor verification is implemented after the check device and the payment device verifies each other. In this way, even if the payment device is lost or information about the card is thieved, because the check device needs to be Ruther verified for a small-amount PIN-less transaction, unauthorized payment is not performed, thereby achieving higher security and better user experience.

Optionally, the check device 500 may further include a storage unit 540, and the storage unit 540 may be configured to store code executed by the receiving unit 510, the processing unit 520, and the sending unit 530.

Optionally, in an embodiment, the receiving unit 510 is further configured to: before the sending unit 530 sends the PIN-less answer information to the payment device, receive the PIN-less identifier that is sent by a server for the transaction, where the PIN-less identifier is generated by the server based on PIN-less verification request information sent by the payment device.

Optionally, in an embodiment, the receiving unit 510 is further configured to: before the sending unit 530 sends the PIN-less answer information to the payment device, receive a first encryption key in a first key pair sent by the server, where the first key pair includes the first encryption key and a first decryption key; and the processing unit 520 is further configured to: encrypt or sign the PIN-less identifier by using the first encryption key.

Optionally, in an embodiment, the processing unit 520 is specifically configured to: decrypt the PIN-less request information by using a second decryption key in a second key pair, where the second key pair is generated through negotiation between the payment device and the check device, and the second key pair includes a second encryption key and the second decryption key.

It should be understood that the check device 500 according to this embodiment of the present invention may correspond to the check device in the embodiments of the present invention, and the foregoing and other operations and/or functions of each unit of the check device 500 implement a corresponding procedure of each method in FIG. 5 and FIG. 6. For brevity, details are not described herein again.

It should be noted that in an embodiment of the present invention, the receiving unit 510 may be implemented by a receiver, the processing unit 520 may be implemented by a processor, the sending unit 530 may be implemented by a transmitter, and the storage unit 540 may be implemented by a memory. As shown in FIG. 11, a check device 600 may include a receiver 610, a processor 620, a transmitter 630, and a memory 640. The receiver 610, the processor 620, the transmitter 630, and the memory 640 in FIG. 11 communicate with each other, and transfer a control and/or data signal by using an internally connected channel. The memory 640 is configured to store program code, and the receiver 610, the processor 620, and the transmitter 630 are configured to invoke the program code to implement the methods in the foregoing embodiments of the present invention.

It should be understood that the check device 600 shown in FIG. 11 may correspond to the check device in the embodiments of the present invention, and the foregoing and other operations and/or functions of each unit of the check device 600 implement a corresponding procedure of each method in FIG. 5 and FIG. 6. For brevity, details are not described herein again.

In an embodiment of the present invention, the processor 620 may be a central processing unit (central processing unit, CPU), a network processor (network processor, NP), or a combination of a CPU and an NP. The processor may further include a hardware chip. The hardware chip may be an application-specific integrated circuit (application-specific integrated circuit, ASIC), a programmable logic device (programmable logic device, PLD), or a combination thereof.

A structure of the payment device or the check device in the embodiments of the present invention is described in detail below by using an example in which the payment device or the check device is a smartphone. It should be understood that the smartphone is used as an example merely for ease of description, and should not constitute a limitation on die protection scope of the embodiments of the present invention.

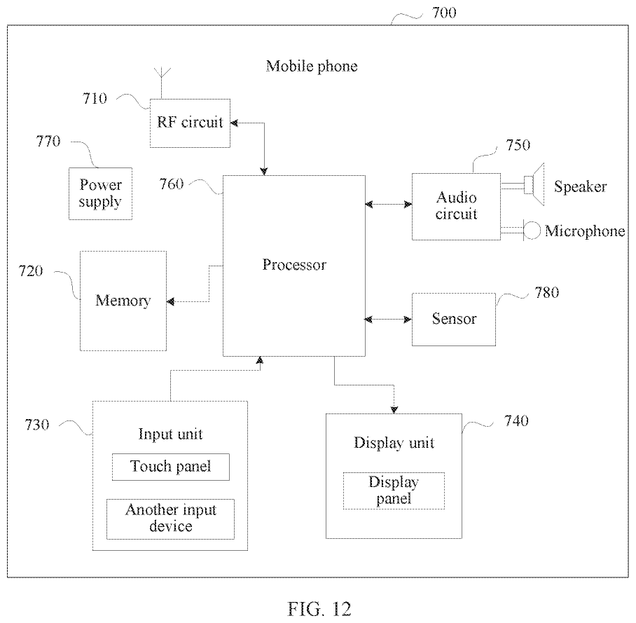

FIG. 12 is a schematic block diagram of a part of a structure of a smartphone 700 related to a payment device or a check device according to an embodiment of the present invention. Referring to FIG. 12, the smartphone 700 includes such components as a radio frequency (radio frequency, RF) circuit 710, a memory 720, an input unit 730, a display unit 740, an audio circuit 750, a processor 760, a power supply 770, and a sensor 780. A person skilled in the art may understand that the structure of the smartphone shown in FIG. 7 does not constitute a limitation on the smartphone, and the smartphone may include more components or fewer components than those shown in the figure, or some components may be combined, or a different component deployment may be used.

For example, the smartphone may further include a camera, a Wireless Fidelity (wireless fidelity, WiFi) module, and the like. Details are not described herein again.

In this embodiment of the present invention, the RF circuit 710 may be configured to send or receive information, or send or receive a signal to be processed by the processor 720 in a call process. For example, generally, the RF circuit 710 includes but is not limited to an antenna, at least one amplifier, a transceiver, a coupler, a low noise amplifier (low noise amplifier, LNA), and a duplexer. The RF circuit may include but is not limited to a radio frequency identification (radio frequency identification, RFID) technology-based NFC, used for contactless near field communication. In addition, the RF circuit 710 may further communicate with a network and another device through wireless communication. The wireless communication may use any communication standard or protocol, which includes, but is not limited to, Global System for Mobile communications (global system of mobile communication, GSM), General Packet Radio Service (general packet radio service, GPRS), Code Division Multiple Access (code division multiple access, CDMA). Wideband Code Division Multiple Access (wideband code division multiple access, WCDMA), Long Term Evolution (long term evolution, LTE), email, short message service (short messaging service, SMS), and the like.

The memory 720 may be configured to store a software program and module. The processor 760 runs the software program and module stored in the memory 720, to implement various functional applications and data processing of the mobile phone 700. The memory 720 may mainly include a program storage area and a data storage area, where the program storage area may store an operating system, an application program required by at least one function (such as a sound playback function and an image display function), and the like; and the data storage area may store data (such as audio data and a telephone directory) created according to use of the mobile phone 700, and the like. In addition, the memory 720 may include a high-speed random access memory, and may further include a non-volatile memory, such as at least one magnetic disk storage device, a flash storage device, or another volatile solid-state storage device.

The input unit 730 may be configured to: receive input digit or character information, and generate a keyboard signal input related to the user setting and function control of the smartphone 700. Specifically, the input unit 730 may include a touch panel and another input device. The touch panel, also referred to as a touchscreen, may collect a touch operation of a user on or near the touch panel (such as an operation of a user on or near the touch panel by using any suitable object or accessory such as a finger or a stylus), and drive a corresponding connection apparatus according to a preset program. Optionally, the touch panel may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor. Moreover, the touch controller can receive and execute a command sent from the processor. In addition, the touch panel may be implemented into a plurality of types such as a resistive, capacitive, infrared, or surface acoustic wave type touch panel. In addition to the touch panel, the input unit may further include another input device. Specifically, the another input device may include, but is not limited to, one or more of a physical keyboard, a functional key (such as a volume control key or a switch key), a track ball, a mouse, a joy stick, and the like.

The display unit 740 may be configured to display information input by the user or information provided for the user, and various menus of the device. The display unit 740 may include a display panel. Optionally, the display panel may be configured in a form of a liquid crystal display (LCD), an organic light-emitting diode (OLED), or the like. Further, the touch panel may cover the display panel. After detecting a touch operation on or near the touch panel, the touch panel transfers the touch operation to the processor, to determine a type of the touch event. Then, the processor 760 provides a corresponding visual output according to the type of the touch event. Although, in FIG. 12, the touch panel and the display panel are used as two separate parts to implement input and output functions of the smartphone 700, in some embodiments, the touch panel and the display panel may be integrated to implement the input and output functions of the smartphone 700.

The audio circuit 750, a speaker, and a microphone may provide an audio interface between the user and the smartphone 700. The audio the circuit 750 may convert received audio data into an electrical signal and transmit the electrical signal to the speaker, and the speaker converts the electrical signal into a sound signal for outputting. On the other hand, the microphone converts a collected sound signal into an electrical signal, and the audio the circuit 750 receives the electrical signal, converts the electrical signal into audio data, and outputs the audio data to the memory 720 for further processing.

The processor 760 is a control center of the smartphone 700, and is connected to each part of the entire smartphone 700 by using various interfaces and lines. By running or executing a software program and/or module stored in the memory, and invoking data stored in the memory 720, the processor 760 performs various functions and data processing of the smartphone 700, thereby performing overall monitoring on the smartphone 700. Optionally, the processor 760 may include one or more processing units. Preferably, the processor 760 may integrate an application processor and a modem processor. The application processor mainly processes an operating system, a user interface, an application program, and the like. The modem processor mainly processes wireless communication. It may be understood that the foregoing modem processor may alternatively not be integrated into the processor 760.

The power supply 770 (such as a battery) is configured to supply power to the components. Preferably, the power supply may be logically connected to the processor by using a power management system, thereby implementing functions such as charging, discharging and power consumption management by using the power management system.

The mobile phone 700 may further include at least one sensor 780 such as an optical sensor, a motion sensor, and another sensor. Specifically, the optical sensor may include an ambient light sensor and a proximity sensor. The ambient light sensor may adjust brightness of the display unit 740 based on brightness of ambient light. As one type of motion sensor, an acceleration sensor can detect magnitude of accelerations in various directions (generally on three axes), can detect magnitude and a direction of the gravity when the mobile phone 700 is static, and may be applied to an application that recognizes a gesture of the mobile phone (for example, switching between landscape orientation and portrait orientation, a related game, and magnetometer gesture calibration), a function related to vibration recognition (such as a pedometer and a knock), and the like. As for other sensors such as a gyroscope, a barometer, a hygrometer, a thermometer, and an infrared sensor that may be further configured for the mobile phone 700, details are not described herein.

It should be understood that, the structure of the smartphone 700 shown in FIG. 12 constitutes any limitation neither on the smartphone nor the payment device or the check device in the embodiments of the present invention. For example, the check device related to the embodiments of the present invention may not include such components as the audio circuit 750 and the sensor 780 shown in FIG. 12. This is not limited in this embodiment of the present invention.

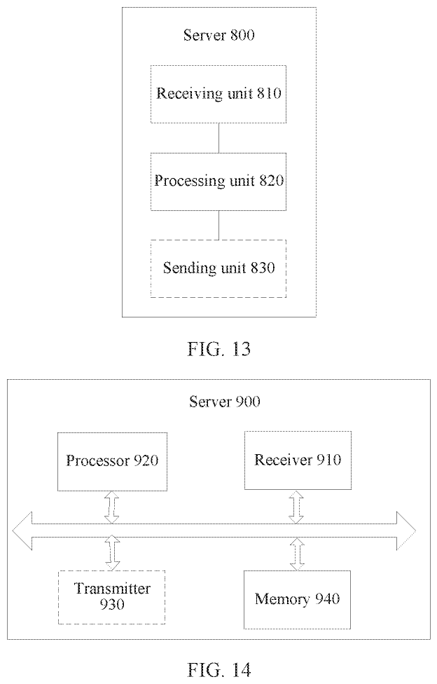

FIG. 13 is a schematic block diagram of a server 800 according to an embodiment of the present invention. It should be understood that the server embodiment corresponds to the method embodiment, and for similar descriptions, refer to the method embodiment. The server 800 shown in FIG. 13 corresponds to the issuing bank host in FIG. 5 and FIG. 6. The server 800 includes:
a receiving unit 810, configured to receive an authorization request packet salt by a point of sale device PoS machine, where the authorization request packet includes an authorization request cryptogram ARQC, the ARQC includes a PIN-less identifier that is associated with a check device and that corresponds to a card required for a transaction, the PIN-less identifier is used by the server to learn that the card has a PIN-less capability, the ARQC is sent by a payment device to the PoS machine, and the payment device, the check device, and the card are already associated with each other; and
a processing unit 820, configured to verify, based on the ARQC, whether the transaction is valid.

Optionally, the server 800 may further include a storage unit 840, and the storage unit 840 may be configured to store code executed by the receiving unit 810 and the processing unit 820.

Optionally, in an embodiment, the receiving unit 810 is further configured to; before receiving the authorization request packet sent by the PoS machine, receive PIN-less verification request information sent by the payment device, where the PIN-less verification request information is used to request the PIN-less identifier for the check device; the processing unit 820 is further configured to; generate, based on the PIN-less verification request information, the PIN-less identifier, and determine a PIN-less limit corresponding to the PIN-less identifier; and the server 800 may further include a sending unit 830, and the sending unit 830 is configured to send the PIN-less identifier to the check device.

Optionally, in an embodiment, the processing unit 820 is specifically configured to: when decrypting the ARQC and determining that the PIN-less identifier is valid and a transaction amount is less than or is equal to the PIN-less limit, determine that the transaction is PIN-less; or when decrypting the ARQC and determining that the PIN-less identifier is invalid, reject the transaction, or when determining that a transaction amount is greater than the PIN-less limit, determine that a password needs to be entered for the transaction.

Optionally, in an embodiment, the processing unit 820 is further configured to: before the receiving unit 810 receives the authorization request packet sent by the PoS machine, generate a first key pair, where the first key pair includes a first encryption key and a first decryption key: the sending unit 830 is further configured to send the first encryption key to the check device, where the first encryption key is used by the check device to encrypt or sign the PIN-less identifier; and the processing unit 820 is specifically configured to determine, by using the first decryption key in the first key pair, whether the PIN-less identifier is valid.

According to the server in this embodiment of the present invention, two-factor verification is implemented after the PIN-less identifier stored in the check device and information about the card in the payment device are verified. In this way, even if the payment device is lost or the information about the card is thieved, because the check device further needs to be verified for a small-amount PIN-less transaction, authorization is not performed for the transaction, thereby achieving higher security and better user experience.

It should be understood that the server 800 according to this embodiment of the present invention may correspond to the issuing bank host in the embodiments of the present invention, and the foregoing and other operations and/or functions of each unit of the server 800 implement a corresponding procedure of each method in FIG. 5 and FIG. 6. For brevity, details are not described herein again.

It should be noted that in an embodiment of the present invention, the receiving unit 810 may be implemented by a receiver, the processing unit 820 may be implemented by a processor, the sending unit 830 may be implemented by a transmitter, and the storage unit 840 may be implemented by a memory. As shown in FIG. 14, a server 900 may include a receiver 910, a processor 920, a transmitter 930, and a memory 940. The receiver 910, the processor 920, the transmitter 930, and the memory 940 in FIG. 14 communicate with each other, and transfer a control and/or data signal by using an internally connected channel. The memory 940 is configured to store program code, and the receiver 910, the processor 920, and the transmitter 930 are configured to invoke the program code to implement the methods in the foregoing embodiments of the present invention.

It should be understood that the server 900 shown in FIG. 14 may correspond to the issuing bank host in the embodiments of the present invention, and the foregoing and other operations and/or functions of each unit of the server 900 implement a corresponding procedure of each method in FIG. 5 and FIG. 6. For brevity, details are not described herein again.

In an embodiment of the present invention, the processor 920 may be a central processing unit (central processing unit, CPU), a network processor (network processor, NP), or a combination of a CPU and an NP. The processor may further include a hardware chip. The hardware chip may be an application-specific integrated circuit (application-specific integrated circuit, ASIC), a programmable logic device (programmable logic device, PLD), or a combination thereof.

An embodiment of the present invention further provides a computer-readable medium configured to store computer program code, and the computer program includes an instruction for performing the transaction method in the embodiments of the present invention in FIG. 5 and FIG. 6. The readable medium may be a read-only memory (read-only memory, ROM) or a random access memory (random access memory, RAM). This is not limited in this embodiment of the present invention.

It should be understood that, the term “and/or” and “at least one of A or B” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units. Some or all of the units may be selected according to actual requirements to achieve the objectives of the solutions of the embodiments.

In addition, function units in the embodiments of this application may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the prior art, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of this application. The foregoing storage medium includes, any medium that can store program code, such as a USB flash drive, a removable hard disk, a ROM, a RAM, a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A transaction method, wherein the transaction method is implemented by a payment device, and wherein the transaction method comprises:
sending personal identification number (PIN)-less request information to a check device to request a PIN-less identifier, wherein the PIN-less identifier indicates that a card for a transaction has a PIN-less capability, wherein the PIN-less identifier is associated with the check device and corresponds to the card, and wherein the payment device, the check device, and the card are associated with each other;
receiving PIN-less answer information from the check device in response to the PIN-less request information, wherein the PIN-less answer information comprises the PIN-less identifier;
modifying a cardholder verification method (CVM) list of the card based on the PIN-less answer information to enable a point of sale (PoS) machine to learn that the transaction is a PIN-less transaction;
generating an authorization request cryptogram (ARQC) based on the PIN-less answer information; and
sending the ARQC to the PoS machine to generate an authorization request packet and to send the authorization request packet to a server for the transaction, wherein the ARQC comprises the PIN-less identifier and wherein the authorization request packet comprises the ARQC.

2. The transaction method of claim 1, wherein modifying the CVM list comprises setting, in the CVM list, a service condition of an online PIN to be that a transaction amount is greater than a PIN-less limit, and wherein the PIN-less limit corresponds to the PIN-less identifier.

3. The transaction method of claim 1, wherein modifying the CVM list comprises:
adding a consumer device cardholder verification method (CDCVM) to a CVM type in the CVM list; and
recording a result of the CDCVM as verification succeeds.

4. The transaction method of claim 1, wherein before sending the PIN-less request information to the check device, the transaction method further comprises sending PIN-less verification request information requesting the PIN-less identifier for the check device to the server to enable the server to generate the PIN-less identifier based on the PIN-less verification request information, to determine a PIN-less limit corresponding to the PIN-less identifier, and to send the PIN-less identifier to the check device.

5. Ille transaction method of claim 1, wherein the check device is configured to encrypt or sign the PIN-less identifier using a first encryption key in a first key pair, and wherein the first encryption key is configured to be sent by the server to the check device.

6. The transaction method of claim 1, wherein sending the PIN-less request information to the check device comprises:
negotiating with the check device to generate a second key pair, wherein the second key pair comprises a second encryption key and a second decryption key;
encrypting the PIN-less request information using the second encryption key to obtain encrypted PIN-less request information; and
sending, to the check device, the encrypted PIN-less request information.

7. The transaction method of claim 1, wherein the payment device is a first mobile phone and the check device is a first wearable device, or wherein the payment device is a second wearable device and the check device is a second mobile phone.

8. A transaction method, wherein the transaction method is implemented by a check device, and wherein the transaction method comprises:
receiving, from a payment device, personal identification number (PIN)-less request information requesting a PIN-less identifier, wherein the PIN-less identifier indicates that a card for a transaction has a PIN-less capability, wherein the PIN-less identifier is associated with the check device and corresponds to the card, and wherein the payment device, the check device, and the card are associated with each other;
parsing the PIN-less request information; and
sending PIN-less answer information to the payment device in response to the PIN-less request information to enable the payment device to modify a cardholder verification method (CVM) list of the card, wherein the PIN-less answer information comprises the PIN-less identifier.

9. The transaction method of claim 8, wherein before sending the PIN-less answer information to the payment device, the transaction method further comprises receiving the PIN-less identifier from a server for the transaction, and wherein the PIN-less identifier is based on PIN-less verification request information from the payment device.

10. The transaction method of claim 8, wherein before sending the PIN-less answer information to the payment device, the transaction method further comprises:
receiving a first encryption key in a first key pair from a server, wherein the first key pair comprises the first encryption key and a first decryption key; and
encrypting or signing the PIN-less identifier using the first encryption key.

11. The transaction method of claim 8, wherein parsing the PIN-less request information comprises:
negotiating with the payment device to generate a second key pair, wherein the second key pair comprises a second encryption key and a second decryption key; and
decrypting the PIN-less request information using the second decryption key.

12. The transaction method of claim 8, wherein the check device is a first wearable device and the payment device is a first mobile phone, or wherein the check device is a second mobile phone and the payment device is a second wearable device.

13.-37. (canceled)

38. A payment device, comprising:
a memory configured to store instructions; and
a processor coupled to the memory, wherein the instructions are executed by the processor to cause the payment device to be configured to:
send personal identification number (PIN)-less request information to a check device to request a PIN-less identifier, wherein the PIN-less identifier indicates that a card for a transaction has a PIN-less capability, wherein the PIN-less identifier is associated with the check device and corresponds to the card, and wherein the payment device, the check device, and the card are associated with each other;
receive PIN-less answer information from the check device in response to the PIN-less request information, wherein the PIN-less answer information comprises the PIN-less identifier;
modify a cardholder verification method (CVM) list of the card based on the PIN-less answer information;
generate an authorization request cryptogram (ARQC) based on the PIN-less answer information; and
send the ARQC to a point of sale (PoS) machine to generate an authorization request packet and to send the authorization request packet to a server for the transaction, wherein the ARQC comprises the PIN-less identifier, and wherein the authorization request packet comprises the ARQC.

39. The payment device of claim 38, wherein the instructions are further executed by the processor to cause the payment device to set, in the CVM list, a service condition of an online PIN to be that a transaction amount is greater than a PIN-less limit, and wherein the PIN-less limit corresponds to the PIN-less identifier.

40. The payment device of claim 38, wherein the instructions are further executed by the processor to cause the payment device to:
add a consumer device cardholder verification method (CDCVM) to a CVM type in the CVM list; and
record a result of the CDCVM as verification succeeds.

41. The payment device of claim 38, wherein the instructions are further executed by the processor to cause the payment device to send PIN-less verification request information to the server, and wherein the PIN-less verification request information requests the PIN-less identifier for the check device.

42. The payment device of claim 38, wherein the check device is configured to encrypt or to sign the PIN-less identifier by using a first encryption key in a first key pair, and wherein the first encryption key is configured to be sent by the server to the check device.

43. The payment device of claim 38, wherein the instructions age further executed by the processor to cause the payment device to:
negotiate with the check device to generate a second key pair, wherein the second key pair comprises a second encryption key and a second decryption key;
encrypt the PIN-less request information using the second encryption key to obtain encrypted PIN-less request information; and
send, to the check device, the encrypted PIN-less request information.

44. The payment device of claim 38, wherein the payment device is a mobile phone and the check device is a wearable device.

45. The payment device of claim 38, wherein the payment device is a wearable device and the check device is a mobile phone.
